(19) United States
(12) Patent Application Publication
(10) Pub. No.: US 2014/0298107 A1
(43) Pub. Date: Oct. 2, 2014

(54) Dynamic Near Real-Time Diagnostic Data Capture

(71) Applicant: MICROSOFT CORPORATION, Redmond, WA (US)

(72) Inventors: Robert Dreyfoos, Kirkland, WA (US); Stephan Doll, Seattle, WA (US); Greg Nichols, Bellevue, WA (US); Robin Giese, Mercer Island, WA (US)

(73) Assignee: Microsoft Corporation, Redmond, WA (US)

(21) Appl. No.: 13/853,081

(22) Filed: Mar. 29, 2013

(51) Int. Cl. G06F 11/30

(52) U.S. Cl. CPC G06F 11/3055
USPC 714/39

(57) ABSTRACT

To improve identifying and tracking errors on a computer, an operating system for a computer is programmed to have a framework allowing programmable monitors of events to be defined. These programmable monitors are programmed to detect one or more events or patterns of events, and have associated actions. When the pattern of events occurs, the monitor is triggered, and actions associated with the monitor can be performed. Various actions can be performed, including but not limited to data gathering about the events triggering the monitor, other events occurring during the same time period, and information about the configuration of the computer. Monitors can be dynamically updated remotely during operation of the computer. An operating system can be programmed to have any number of such monitors. Similarly, the actions that occur when a monitor is triggered also can be dynamically updated.

### BACKGROUND

In commercial software development, there is often a significant time delay between errors or performance problems occurring with software in the hands of end users, and the cause of such errors or performance problems being identified and resolved. Because errors and performance problems can have many causes, it is often useful to analyze event logs and other information retained by the computer running the software.

While there are a variety of tools available that can perform tracing and other functions while software is running, often such tools involve having a user download software or perform specific steps under guidance of customer service personnel. In some cases, customer service personnel remote access a machine to perform diagnostic tests.

With current processes, there are delays in development and a negative end user experience associated with fixing errors in software.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

To improve identifying and tracking errors on a computer, an operating system for a computer is programmed to have a framework allowing programmable monitors of events to be defined. These programmable monitors are programmed to detect one or more events or patterns of events, and have associated actions. When the pattern of events occurs, the monitor is triggered, and actions associated with the monitor can be performed. Various actions can be performed, including but not limited to data gathering about the events triggering the monitor, other events occurring during the same time period, and information about the configuration of the computer.

Monitors can be dynamically updated remotely during operation of the computer. An operating system can be programmed to have any number of such monitors. Similarly, the actions that occur when a monitor is triggered also can be dynamically updated.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example computing environment for implementing a dynamic diagnostic tool.

FIG. 2 is a more detailed block diagram of an example implementation of a system such as shown in FIG. 1.

FIG. 3 is a flow chart describing an example operation of the system in FIG. 1.

FIG. 4 is a flow chart describing an example operation of the system in FIG. 1

FIG. 5 is a block diagram of an example computing device with which components of such a system can be implemented.

### DETAILED DESCRIPTION

The following section provides an example computing environment in which the dynamic diagnostic tool can be implemented.

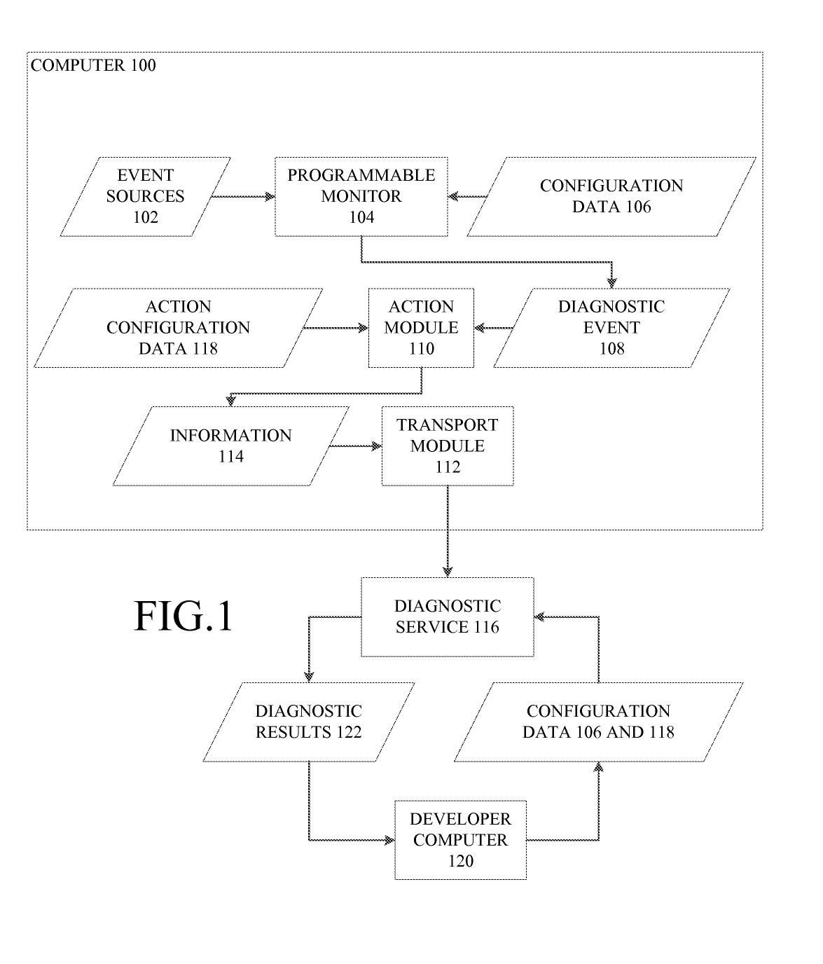

Referring to FIG. 1, a computer 100 has an operating system (not shown) and applications that maintain sources of data about events occurring within the computer. These sources of data are indicated in FIG. 1 as event sources 102 within the computer 100. An event source can be, for example, the Event Tracing for Windows (ETW) mechanism in Windows operating systems, or similar capabilities in other operating systems such as the DTrace event tracer in the Solaris operating system and the ptrace event tracer in the Linux operating system. More diagnostic capabilities are provided if such event sources are providing a frequent and rich source of event information.

For example, an event from an event source generally is a data structure that has information describing an event occurrence in the operating system. The event data structure has a provider identifier, uniquely identifying the provider of the event, and an event identifier. The event data structure can include a process identifier, thread identifier, time stamp, keywords, version number, level and activity information. Other information may be provided depending on the application, user settings and the like.

A programmable monitor 104 monitors data from the event sources, according to event configuration data 106, to detect the occurrence of diagnostic events. The configuration data 106 defines diagnostic events in terms of one or more events that can occur in the event sources 102.

If a diagnostic event is detected, as indicated at 108, then an action module 110 is triggered. The action module 110 can perform a variety of actions in response to detection of a diagnostic event, such as, but not limited to, generating reports and escalation information, and gathering data. The actions that can be performed similarly are configurable, based on action configuration data 118. Examples of such actions include, but are not limited to, reading registry keys, starting a trace, copying a file and the like.

A transport module 112 receives information 114 generated by the action module 110 and transmits it to a diagnostic service 116. Prior to transmission, any personal information or personally identifying information is anonymized.

The transport module 112, configurable action modules 110 and programmable monitors 104 reside on the computer on which diagnostic evaluation occurs. This computer also can include a user interface through with the user of the computer can request diagnostic scenarios be developed for the computer around a user driven issue.

The diagnostic service comprises one or more computers that connect to the computer 100 through a computer network (not shown) to exchange the configuration data 106, action configuration data 118 and information 114. The diagnostic service can connect to multiple computers 100 distributed throughout a computer network. Developers access the diagnostic service, typically from developer computers 120, to provide the configuration data 106 and 118, defining a diagnostic scenario, and review results 122 provided from diagnostic monitoring, i.e., information 114. With this information 114 in response to monitors that they create, developers can more efficiently work on errors and performance problems. The computers 100 to which a diagnostic scenario is applied also can be targeted. For example, characteristics of a machine configuration, such as presence or absence of specific files or versions of files, registry keys, operating system settings, services, applications and the like, can be used to select a machine to which a diagnostic scenario is applied.

For the target computer to load a diagnostic scenario securely, the target computer validates the information received from the diagnostic service. For example, the communication channel used by the target computer to communicate with the diagnostic service can be the secure hypertext transfer protocol (HTTPS), with the target computer doing full validation of the server's root certificate. As another example, the configuration data can be digitally signed and/or encrypted and the operating system of the target computer can authenticates, decrypt and validates the configuration data before using it.

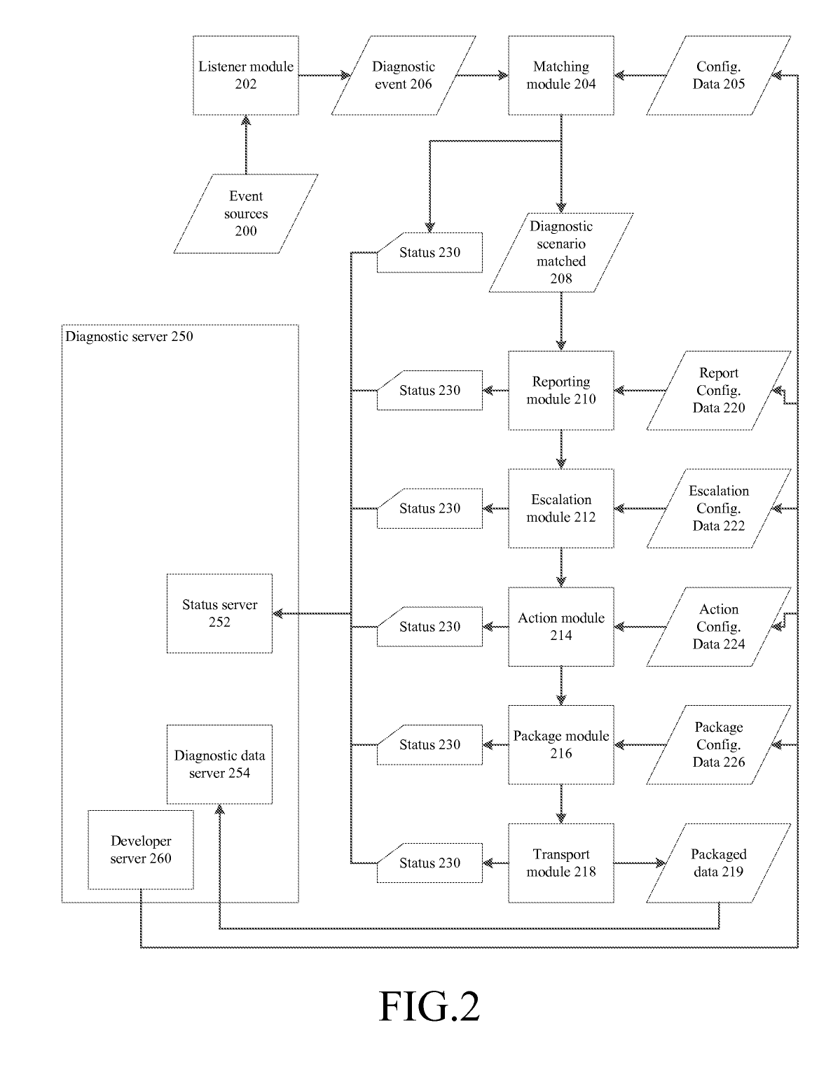

Given this context, an example implementation of dynamic diagnostic system will be described in more detail in connection with FIGS. 2-4.

In FIG. 2, event sources 200 are monitored by a programmable monitor that includes a listener module 202 and a matching module 204. The listener module 202 is configured to identify and detect diagnostic events 206 in a stream of event data from the event sources 200. The matching module 204 receives data defining a diagnostic event and is configured to identify one or more diagnostic scenarios which use the diagnostic event. It is possible for a computer to have multiple listening modules, each identifying different diagnostic events. It is possible for a computer to have a matching module that can match multiple diagnostic scenarios to a diagnostic event. Modules 204 and 202 are configured by configuration data 205.

When a diagnostic scenario is matched, that information 208 is passed to action modules, which in this example include a reporting module 210, escalation module 212, action module 214, package module 216 and transport module 218.

Reporting module 210 is configured by report configuration data 220 and generates data reporting the occurrence of an event to the diagnostic service. Escalation module 212 is configured by escalation configuration data 222 and determines a priority level to assign to the event, typically based on the nature of the event, such as whether it is a repeated error or security risk.

Action module 214 is configured by action configuration data 224 and identifies the actions to be performed, such as gathering data, in response to a diagnostic event. Package module 216 is configured by package configuration data 226 and packages data for transport to the diagnostic service. Transport module 218 handles communication with the diagnostic services to transfer packaged data 219 to the diagnostic service.

Each of these modules can provide its own status information to the diagnostic server 250, as indicated at 230. Such status information about the scenario can include errors for not loading or execution and success responses at various points during execution of the scenario.

The diagnostic server 250 can be implemented using a set of servers, such as a status server 252 for the diagnostic status information from the various modules, and another diagnostic data server 254 for the packaged diagnostic data received from a specific computer for a specific diagnostic scenario.

On the development side, a developer server 260 maintains the data defining various diagnostic scenarios and the machines for which they are targeted. The developer server can be connected over a computer network such as the internet to multiple users' computers, in the same manner that such connections are made to maintain automatic updates of software as is commonly done with commercial software.

One or more developers access the developer server 260 to upload and assign diagnostic scenarios to targeted computers.

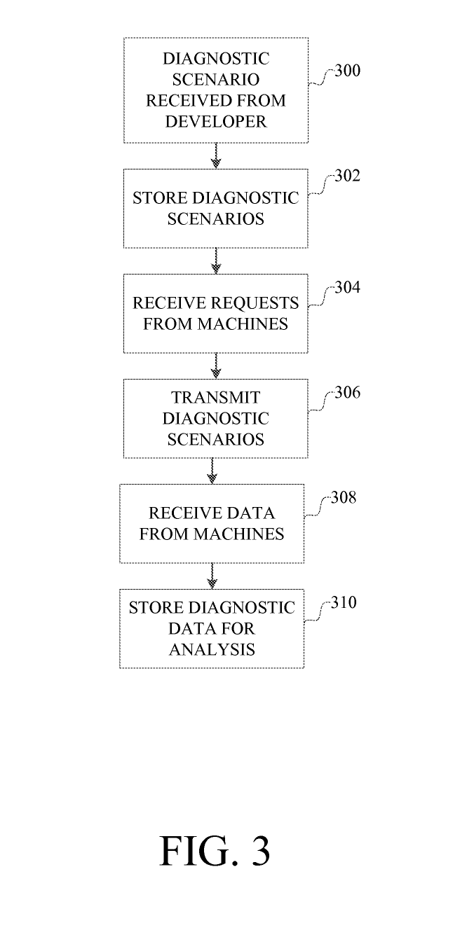

A flowchart in FIG. 3 will now be used to describe an example implementation of a system for creating and monitoring a diagnostic scenario, from the perspective of operation of the diagnostic service.

A diagnostic scenario is received 300 from a developer using developer tools such as shown in FIGS. 1 and 2, indicating target machines to which the diagnostic scenario applies. The diagnostic scenario defines one or more diagnostic events as a set of one or more events that can occur in an event data stream from one or more event sources on one or more target machines. The diagnostic scenario is stored 302 on the diagnostic service, ready to be distributed to the targeted machines.

The diagnostic service periodically receives 304 requests from machines, such as for periodic updates or other information. In the same manner as other updates to a computer from a remote, network-connected service, the diagnostic service identifies the diagnostic scenarios for a target machine, and transmits 306 the diagnostic scenarios that have been defined for that target machine to the target machine. Such diagnostic scenarios are distributed to many target machines in this manner.

After downloading and installing diagnostic scenarios in the target machines, diagnostic events may occur and be detected during operation of the target machines. In a target machine, the listener module detects these events. After detection of a diagnostic event, the various other modules gather relevant information from the computer, as specified by the diagnostic scenario. This information is then transmitted to the diagnostic service. The diagnostic service periodically receives 308 data from various target machines relating to the various diagnostic scenarios that have been distributed. Given an indication of the diagnostic scenario, the data from a target machine for a diagnostic scenario can be stored 310. Such stored data can be analyzed by developers to assist in resolving various errors and performance issues.

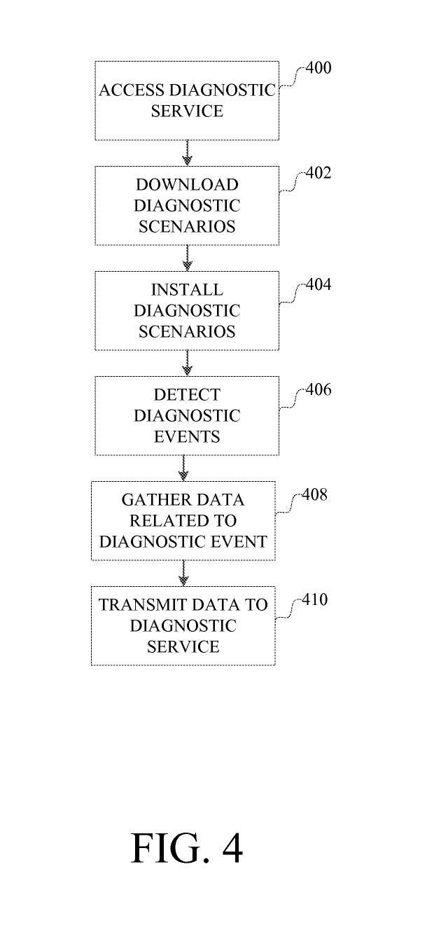

The flowchart of FIG. 4 illustrates this operation from the perspective of a target computer on which diagnostic scenarios can be loaded. Periodically, the computer accesses 400 the diagnostic service and downloads 402 diagnostic scenarios. The computer installs 404 the diagnostic scenarios to program the monitoring and action modules of the computer. While the computer is operating, events are generated within the operating system. The programmed monitoring module detects 406 diagnostic events and, in response, action modules gather 408 data and transmit 410 the data to the diagnostic service.

Diagnostic scenarios can be described in many ways, such as a data structure, data in a markup language, or other data format, typically stored in a data file, and which can be readily interpreted. For example, diagnostic scenarios can be defined using an eXtensible Markup Language (XML) document, with an XML schema definition (XSD) document describing the syntax for data in an XML file defining a specific diagnostic scenario.

As an example implementation, a file of configuration data can define one or more scenarios. Each scenario can have various attributes, such as a name and identifier. A scenario includes a list of one or more triggers, which defines conditions, such as specific events, for which a listener monitors. Thus, a trigger can indicate one or more fields and corresponding values from the event trace data, such as the provider identifier and event identifier. A scenario also includes a list one or more escalations, which defines actions to be taken if the trigger conditions are satisfied. Such actions generally specify operating system commands and parameters for them, such as reading a file or set of files, reading a registry key, reading various operating system or user or application settings, running a script, invoking a process or kernel dump, and the like. Various filters also can be defined within the scenario to specify logical operations to be performed on various data, such as event data, scenario definition or other data, after the trigger conditions are satisfied. The specification of an XSD file is thus dependent on the operating system, and particularly the event trace format for triggers, operating system commands available for escalations and data available for filters.

Having now described an example implementation, a computer with which components of such a system are designed to operate will now be described. The following description is intended to provide a brief, general description of a suitable computer with which such a system can be implemented. The computer can be any of a variety of general purpose or special purpose computing hardware configurations. Examples of well-known computers that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

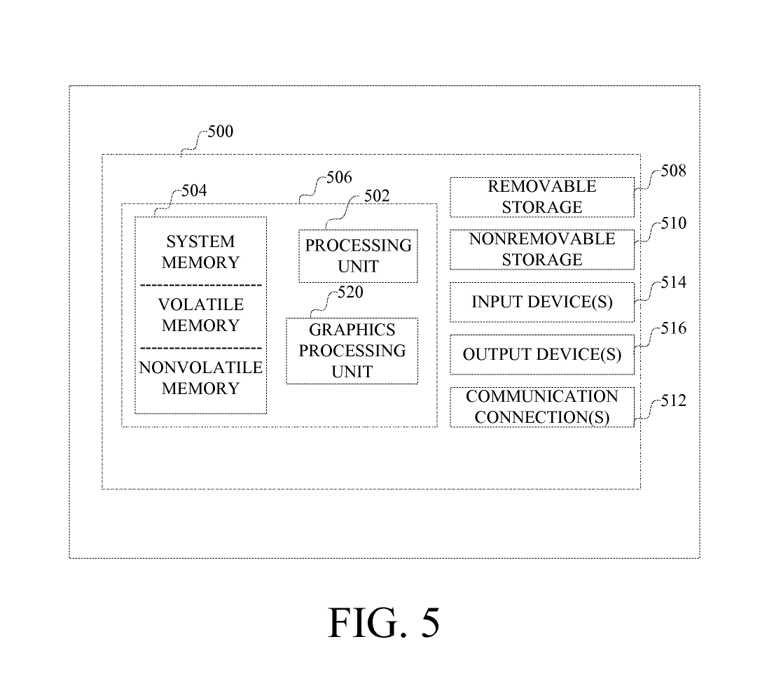

FIG. 5 illustrates an example of a suitable computer. This is only one example of a suitable computer and is not intended to suggest any limitation as to the scope of use or functionality of such a computer.

With reference to FIG. 5, an example computer 500, in a basic configuration, includes at least one processing unit 502 and memory 504. The computer may include multiple processing units and/or additional co-processing units such as graphics processing unit 520. Depending on the exact configuration and type of computer, memory 504 may be volatile (such as RAM), non-volatile (such as ROM, flash memory, etc.) or some combination of the two. This configuration is illustrated in FIG. 5 by dashed line 506.

Additionally, computer 500 may also have additional features/functionality. For example, computer 500 may also include additional storage (removable and/or non-removable) including, but not limited to, magnetic or optical disks or tape. Such additional storage is illustrated in FIG. 5 by removable storage 508 and non-removable storage 510. Computer storage media includes volatile and nonvolatile, removable and non-removable media implemented in any method or technology for storage of information such as computer program instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computer 500. Any such computer storage media may be part of computer 500.

Computer 500 may also contain communications connection(s) 515 that allow the device to communicate with other devices over a communication medium. Communication media typically carry computer program instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. Communications connections 515 are devices that interface with the communication media to transmit data over and receive data from communication media, such as a network interface.

Computer 500 may have various input device(s) 514 such as a keyboard, mouse, pen, camera, touch input device, and so on. Output device(s) 516 such as a display, speakers, a printer, and so on may also be included. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye , and gaze tracking, immersive augmented reality and virtual reality systems, all of which provide a more natural interface, as well as technologies for sensing brain activity using electric field sensing electrodes (EEG and related methods).

Each component of this system that operates on a computer generally is implemented by software, such as one or more computer programs, which include computer-executable instructions and/or computer-interpreted instructions, such as program modules, being processed by the computer. Generally, program modules include routines, programs, objects, components, data structures, and so on, that, when processed by a processing unit, instruct the processing unit to perform particular tasks or implement particular abstract data types. This computer system enforces licensing restrictions may be practiced in distributed computing environments where tasks are performed by remote processing devices that are linked through a communications network. In a distributed computing environment, program modules may be located in both local and remote computer storage media including memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process comprising:
receiving data defining a diagnostic scenario into memory of a computer, the data specifying a diagnostic event and an event source, and indicating actions to be performed if the diagnostic event occurs in the event source;
within a processor of the computer, programming a configurable monitor, using the diagnostic scenario, to monitor the event source for occurrence of the diagnostic event;
after occurrence of the diagnostic event in the event source, performing the action specified by the diagnostic scenario.

2. The computer-implemented process of claim 1, wherein the event source resides in an operating system of the computer.

3. The computer-implemented process of claim 1, wherein the action to be performed includes gathering data about the computer.

4. The computer-implemented process of claim 3, wherein the action to be performed includes transmitting the gathered data to a diagnostic service.

5. The computer-implemented process of claim 1, further comprising:
receiving an updated diagnostic scenario, specifying a different diagnostic scenario;
within the processor of the computer, programming the configurable monitor according to the different diagnostic scenario.

6. The computer-implemented process of claim 1, wherein the configurable monitor comprises a listening module and a matching module, the process further comprising:
the listening module monitoring the event source for occurrence of a plurality of diagnostic events;
the matching module identifying diagnostic scenarios associated with the diagnostic events detected by the listening module.

7. The computer-implemented process of claim 1, further comprising periodically updating the diagnostic scenario through a diagnostic service.

8. A computing machine comprising:
a memory in which data defining one or more diagnostic scenarios is stored, the data specifying a diagnostic event and an event source, and indicating actions to be performed if the diagnostic event occurs in the event source;
within a processor of the computer:
a programmable monitor, the monitor being programmed according to the diagnostic scenario, the monitor detecting occurrence of the diagnostic event in the event source; and
an action module that performs, after occurrence of the diagnostic event in the event source, the action specified by the diagnostic scenario.

9. The computing machine of claim 1, wherein the event source resides in an operating system of the computer.

10. The computing machine of claim 1, wherein the action to be performed includes gathering data about the computer.

11. The computing machine of claim 3, wherein the action to be performed includes transmitting the gathered data to a diagnostic service.

12. The computing machine of claim 1, wherein the programmable monitor can receive an updated diagnostic scenario, specifying a different diagnostic scenario, and can be programmed according to the updated diagnostic scenario.

13. The computing machine of claim 1, wherein the configurable monitor comprises a listening module and a matching module, the listening module monitoring the event source for occurrence of a plurality of diagnostic event, and the matching module identifying diagnostic scenarios associated with the diagnostic events detected by the listening module.

14. The computing machine of claim 8, wherein the computing machine is connected to receive periodic updates of the diagnostic scenario.

15. A diagnostic service, comprising:
a plurality of computers, at least one of the computers being programmed to provide diagnostic scenarios to target computers that access the diagnostic service, a diagnostic scenario being defined by data specifying one or more events and an event source, and indicating actions to be performed if the one or more events occurs in the event source;
first storage media in which data defining the diagnostic scenarios is stored;
second storage media for storing data related to diagnostic events of diagnostic scenarios occurred on target machines;
at least one of the computers being programmed to store data received from target machines on the second storage media.

16. The diagnostic service of claim 15, wherein the event source resides in an operating system of the computer.

17. The diagnostic service of claim 15, wherein the action to be performed includes gathering data about the computer.

18. The diagnostic service of claim 17, wherein the action to be performed includes transmitting the gathered data to a diagnostic service.

19. The diagnostic service of claim 15, wherein the diagnostic service sends updated diagnostic scenarios, specifying a different diagnostic scenario, to multiple target machines.

20. The diagnostic service of claim 15, wherein the action to be performed includes identifying escalating information about the nature of the diagnostic event.
